(19) United States
(12) Patent Application Publication
(10) Pub. No.: US 2022/0271350 A1
(43) Pub. Date: Aug. 25, 2022

(54) FLUORIDE ION BATTERY (FIB) ELECTRODE MATERIAL COATING

(71) Applicant: HONDA MOTOR CO., LTD., Tokyo (JP)

(72) Inventor: Christopher J. BROOKS, Dublin, OH (US)

(21) Appl. No.: 17/674,486

(22) Filed: Feb. 17, 2022

Related U.S. Application Data
(60) Provisional application No. 63/152,135, filed on Feb. 22, 2021.

(51) Int. Cl. H01M 10/36; H01M 10/0569; H01M 10/0568; H01M 4/04; H01M 4/58

(52) U.S. Cl. CPC H01M 10/36; H01M 10/0569; H01M 10/0568; H01M 4/0426; H01M 4/582

(57) ABSTRACT

Fluoride ion and fluoride shuttle batteries comprising specialized, coated electrodes are disclosed herein. Atomic layer deposition and molecular layer deposition methods for preparing coated electrodes for fluoride batteries are disclosed, along with suitable liquid electrolytes, enabling high energy density fluoride ion batteries.

### CROSS-REFERENCE TO RELATED APPLICATIONS

This application claims priority to U.S. Provisional Application No. 63/152,135, filed on Feb. 22, 2021, the contents of which is expressly incorporated by reference herein in its entirety.

### BACKGROUND

Fluoride ion batteries and fluoride shuttle batteries have the potential for high-power, next generation energy storage. The energy densities of fluoride ion batteries can be much higher than lithium ion batteries. Much of the research being conducted is focused on all-solid-state fluoride ion batteries, which may be rechargeable at elevated temperatures to some extent. However, slow reaction kinetics in the solid state impose significant challenges to all-solid-state fluoride ion batteries. Reaction kinetics are faster in liquid type, liquid electrolyte fluoride ion batteries. However, liquid fluoride electrolytes face many challenges, such as the lack of durable cathode and anode materials at room temperature. As energy demands are increasing for high-energy electric vehicles, portable electronic devices, and portable energy storage, there is an increasing need for advanced fluoride ion batteries.

### SUMMARY

The present disclosure is directed to fluoride shuttle batteries and fluoride ion batteries comprising a liquid electrolyte and one or more electrodes with a coating. The electrodes can comprise a core electrode material having various shapes and sizes with one or more coatings. According to some aspects, the coating(s) can prevent dissolution of an electrode in a liquid fluoride electrolyte while improving efficient operation of an electrode in a fluoride ion battery. Various methods of making electrodes for fluoride shuttle batteries and fluoride ion batteries are disclosed herein, enabling a room temperature, high energy fluoride ion or fluoride shuttle battery. The electrodes provided herein can be used with various liquid fluoride electrolytes. For example, a liquid fluoride electrolyte can comprise a non-aqueous solvent and a crown ether-metal fluoride complex including one or more fluoride ions. The crown ether-metal fluoride complex can be at least partially dissolved, and the concentration of the fluoride ions dissolved in the electrolyte composition can be about 0.01 M to about 1 M. A liquid fluoride electrolyte can comprise bis(2-methoxyethyl) ether, bis(2,2,2-trifluoroethyl) ether, N,N,N-trimethyl-N-neopentylammonium fluoride, N,N,N-dimethyl-N,N-dineopentylammonium fluoride, propionitrile, or combinations thereof. The methods disclosed herein for making an electrode material coating can form thin coatings at the atomic level with control of the thickness and composition of the coatings. These aspects and other aspects of the present disclosure are discussed in more detail herein.

### BRIEF DESCRIPTION OF THE DRAWINGS

FIG. 1A depicts energy densities of various types of batteries.

FIG. 1B depicts examples of suitable electrode, anode, and cathode metals/materials, according to some aspects of the present disclosure.

FIG. 1C shows an example cross section of a core-shell nanoparticle or electrode structure including a core comprising a metal nanoparticle or structure, and a shell comprising a metal halide or a metal oxyhalide, according to some aspects of the present disclosure.

FIG. 2 is a schematic illustration of a fluoride ion or fluoride shuttle battery, according to some aspects of the present disclosure.

FIG. 3 is an illustration of decomposition of a tetraalkylammonium fluoride salt under drying conditions to form HF and HF₂⁻.

FIG. 4 is a bar graph of voltage windows measured from linear sweep voltammograms for some non-limiting examples of electrolyte solutions of the present disclosure (BTFE=bis(2,2,2-trifluoroethyl)ether, DME=1, 2-dimethoxyethane, G4=tetraglyme, DMA=N,N-dimethyl acetamide, PN=propionitrile).

FIG. 5A is a cutaway schematic depicting an example solid core electrode material, according to some aspects of the present disclosure.

FIG. 5B is a cutaway schematic depicting an example solid core electrode material with a coating, according to some aspects of the present disclosure.

FIG. 5C is a cutaway schematic depicting an example hollow electrode material, according to some aspects of the present disclosure.

FIG. 6 is a cutaway schematic depicting an electrode material with a coating, according to some aspects of the present disclosure.

FIG. 7A is a cutaway schematic depicting an electrode material with one or more shells or coatings covering the electrode material, according to some aspects of the present disclosure.

FIG. 7B is a cutaway schematic depicting an electrode material with an outer shell or coating partially covering the outer surface, according to some aspects of the present disclosure.

FIG. 8 is a cutaway schematic depicting various configurations of a fluoride battery, according to some aspects of the present disclosure.

FIG. 9A shows a high-resolution TEM image of copper electrode material with a LaF₃ shell or coating, indicating the Cu (core) and LaF₃ (shell or coating) areas.

FIG. 9B shows a high-resolution TEM image of an electrode particle material with a coating or shell, according to some aspects of the present disclosure,

FIG. 9C shows a high-resolution TEM image of electrode particle material with a coating or shell, according to some aspects of the present disclosure.

### DETAILED DESCRIPTION OF THE INVENTION

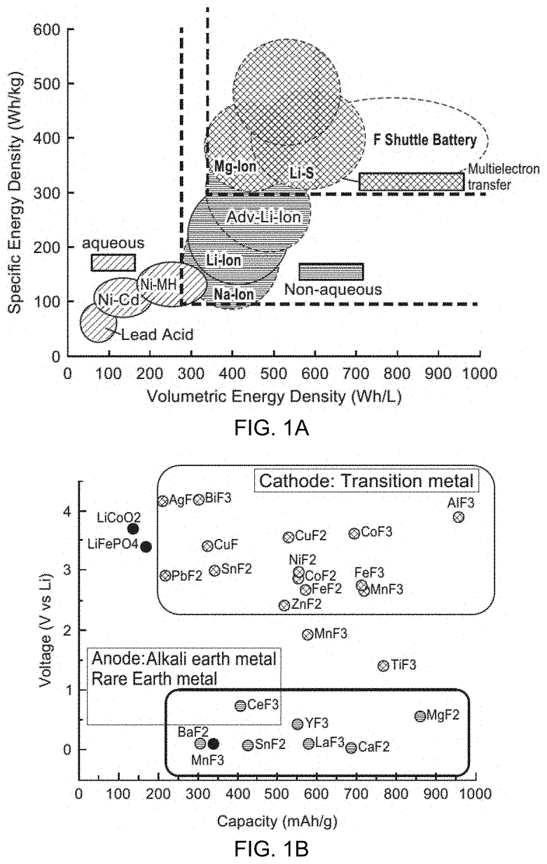

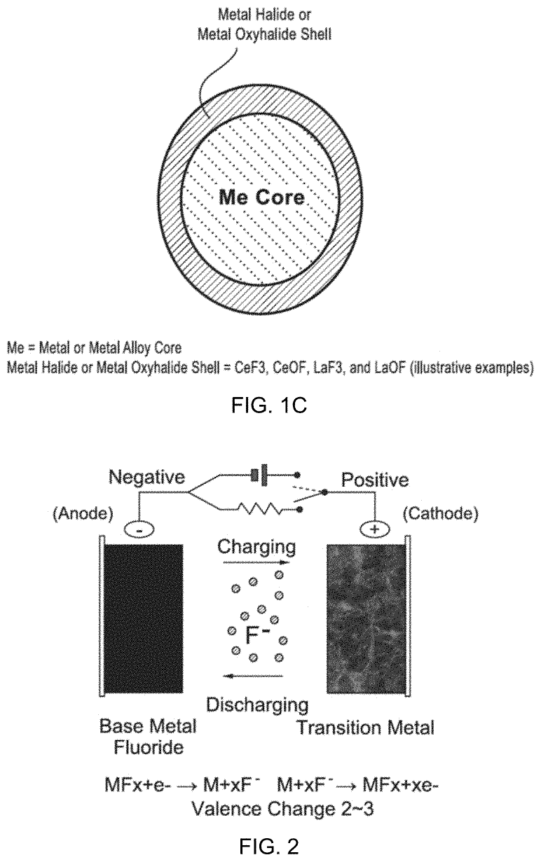

Fluoride ion batteries and fluoride shuttle batteries offer high energy densities and high storage capacities compared to previous types of batteries, but the high energy density presents many challenges, specifically when a liquid electrolyte is utilized. A liquid electrolyte is preferred because, compared to all-solid-state fluoride ion batteries, a liquid electrolyte can offer faster discharge/recharge (kinetics) at room temperature. However, dissolution of the electrodes in a liquid electrolyte is a major challenge. Fluoride ion batteries work by fluoride ion transfer between electrodes. Fluoride shuttle batteries work by fluoride ion transfer, which can involve multiple charge transfers or multiple electron transfers, between electrodes (FIG. 1A, FIG. 2). Both fluoride ion batteries and fluoride shuttle batteries are enabled by the present disclosure, and the terms fluoride ion batteries and fluoride shuttle batteries are used interchangeable herein as a fluoride battery, with some embodiments enabling multiple charge transfer (fluoride shuttle).

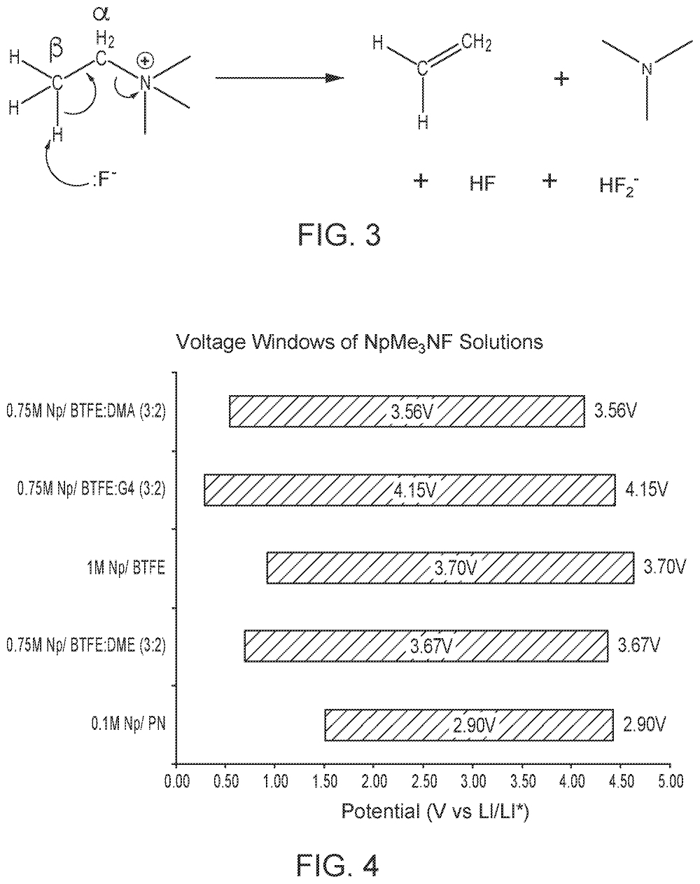

While the high energy density of dissolved (liquid) fluoride is desirable, liquid concentrated hydrofluoric acid can be very corrosive, even dissolving glass and metal when hydrated. Aqueous solutions containing fluoride anion (F—), for electrolytes, show fast reactions of the fluoride ion with water, forming hydrofluoric acid (HF) and the complex ion HF₂— (FIG. 3). Formation of HF is highly corrosive and toxic. Further, HF₂— is much less active than F— in battery applications and, in extreme cases, may be inactive. The formation of HF₂— is also undesirable because it can evolve H₂ at potentials below a cathodic reaction of interest, limiting the useful voltage window in battery applications and potentially causing a failure of a battery comprising the electrolyte.

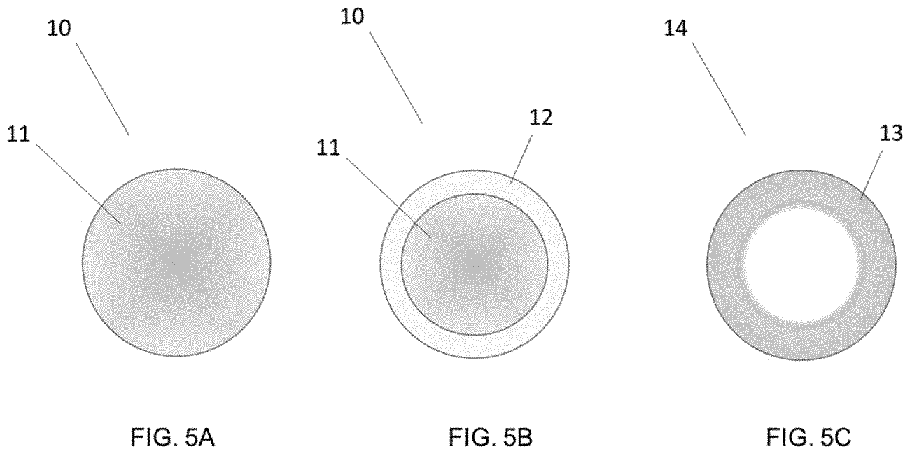

Non-aqueous, organic fluoride electrolyte solutions can be utilized. Metal fluoride electrolyte salts are typically insoluble in organics at concentrations >0.05 M. Organic fluoride electrolyte salts, like those with tetraalkylammonium (R₄N⁺) cations can have improved solubility. However, synthesis of these salts in truly anhydrous form can be challenging because decomposition of F⁻ to HF₂⁻ occurs readily through an elimination processes at elevated temperatures. Neopentyl-substituted (Np, or 2,2-dimethylpropyl-) alkylammonium salts, as the Np chain is both branched (to improve solubility) and lacks β-hydrogens (to inhibit decomposition upon drying) can be utilized in organic solvents for fluoride electrolytes. For example, dry N, N, N-trimethyl-N-neopentylammonium fluoride (N F) and N, N, N-dimethyl-N, N-dineopentylammonium fluoride (Np₂F) can be synthesized using a HF-titration procedure, and both have demonstrated applicability to fluoride ion batteries compared to tetramethylammonium fluoride (TMAF). Various organic solvents provide different levels of electrolyte longevity. For example, BTFE, bis(2,2,2-trifluoroethyl)ether, was found to provide suitable voltage windows (see FIG. 4) and longevity of the electrolyte. Longevity of an electrolyte, in some aspects, can provide F— ions in solution for charge transfer while preventing reactions of F— ions in solution that degrade the electrolyte or other components.

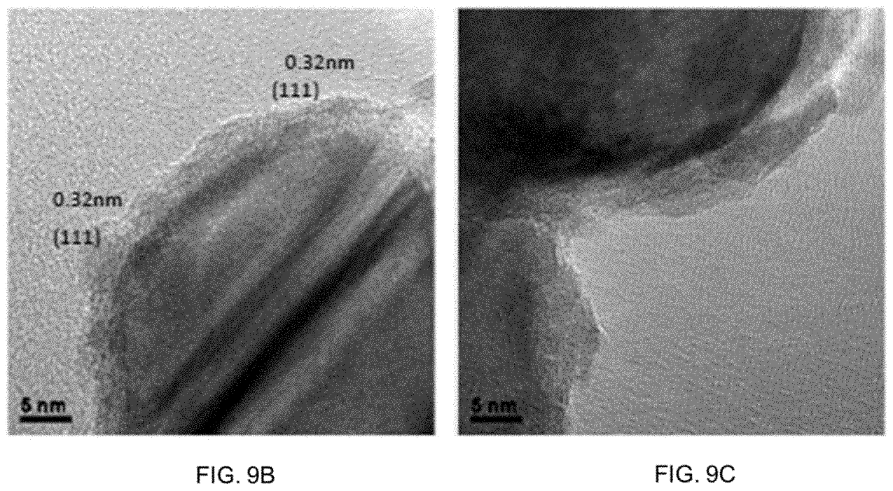

The electrodes disclosed herein are coated, by various methods, to prevent dissolution in a liquid fluoride electrolyte while allowing F— penetration through the coating(s) to the electrode material. In some embodiments, cathodes for fluoride ion batteries are disclosed herein. According to some aspects, a cathode transition metal or a cathode electrode material, as illustrated in FIG. 1B, further comprises one or more shells or layers. In FIG. 1C, a cathode core material is illustrated with a metal halide or metal oxyhalide shell. In some embodiments, the shell may further comprise barium. The cathode core material can have some dimensions on the nanometer scale to improve, for example, efficiency and charge transfer. In some embodiments, the cathode can contain a core-shell material having a transition metal core and one or more shells at least partially surrounding the transition metal core, the outermost layer of the shell(s) in contact with a liquid electrolyte. A non-limiting example of a suitable copper core particle is shown in FIGS. 9B and 9C, which are TEM images of synthesized copper nanoparticles with a LaF₃ shell or coating. According to some aspects, the cathode core structure or core can have a selected shape.

The size of one or more dimensions of an electrode core material may be determined either by electron conductivity or F⁻ ion mobility. In an illustrative example, 20 nm may be the distance limit of F⁻ ion penetration in an electrode core material. If the path of either an electron or F⁻ ion is greater than this distance limit (in this example, 20 nm), electron conductivity and/or F⁻ ion mobility will be reduced or prevented. As such, according to some aspects, the core material may comprise at least one dimension that is less than or equal to about the distance limit. For example, the core may comprise a spherical nanoparticle having a diameter of less than or equal to about the distance limit, as such a spherical nanoparticle will provide a pathway for an electron or F⁻ ion that is less than or equal to about the distance limit in all directions. An electrode core material may have one or more dimensions that are greater than about the distance limit so long as it has a pathway of about the distance limit or less in at least one direction. For example, the core may comprise a sheet having dimensions in the X and Y directions of greater than about the distance limit and a dimension in the Z direction of less than or equal to about the distance limit (e.g., a wire as shown in FIG. 9A). According to some aspects, the distance limit may be about 20 nm, optionally about 30 nm, optionally about 40 nm, and optionally about 50 nm. According to some aspects, the distance limit may be between about 20 and 80 nm, optionally between about 30 and 70 nm, and optionally between about 40 and 60 nm. According to some aspects, the distance limit corresponds at least in part to certain aspects of the core material, for example, and its shell. A shell having a relatively low ionic resistance will provide for a longer distance limit as F⁻ ions are more easily able to traverse the shell to the cathode/electrode core. The thickness of the shell or coating on an electrode material can provide for a longer distance limit as F⁻ ions are more easily able to traverse the shell to the electrode material. In some embodiments, molecular thin uniform coatings or shells can be applied, utilizing the methods disclosed herein, and the thin uniform coatings can increase the distance limit.

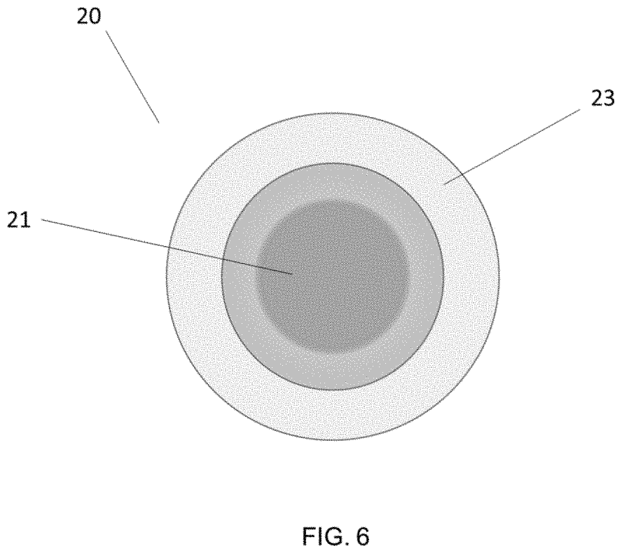

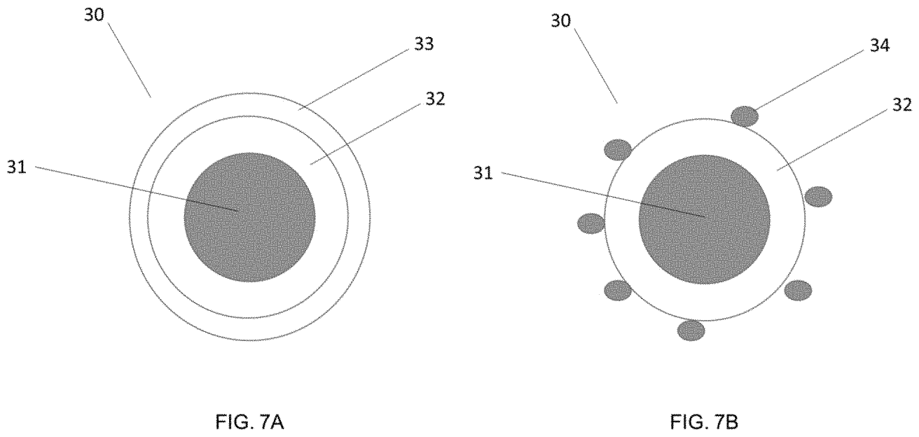

Examples of electrode core structures (or cathode core structures/particles) useful according to the present disclosure include, but are not limited to, a nanoparticle with a diameter of less than or equal to about the distance limit, a nanowire with at least one dimension of less than or equal to about the distance limit, a nanotube having a wall thickness of less than or equal to about the distance limit (FIG. 5C), a flake (e.g., a triangle, rectangle, square, circle, or oval) having a thickness of less than or equal to about the distance limit, a film having a thickness of less than or equal to about the distance limit, a foam having a pore wall thickness of less than or equal to about the distance limit, a sheet or 2D structure having a thickness of less than or equal to about the distance limit, a frame having a thickness of less than or equal to about the distance limit, a mesh having a wire thickness of less than or equal to about the distance limit, and combinations thereof.

The electrode or cathode core further comprises a shell that at least partially surrounds the core. For example, the shell may surround the core such that at least about 50% of the core's surface area is covered by the shell, optionally at least about 60%, optionally at least about 70%, optionally at least about 80%, optionally at least about 90%, optionally at least about 95%, and optionally at least about 100%. For example, the molecular coverage of the shell on the core may be between about 1 and 100 nm⁻², optionally between about 6 and 60 nm⁻². The molecular coverage can, for example, increase if the size of the core increases. In some embodiments, a shell can comprise self-healing or self-fixing, flexible properties, depending on the composition or form of the shell, which can be determined using the various methods disclosed herein.

According to some aspects, the shell at least partially surrounding the electrode or cathode core has a thickness about 0.1 angstrom (atomic level) to 1 micron, optionally no more than 500 nm, optionally no more than 200 nm, optionally no more than 100 nm, optionally no more than 50 nm, optionally no more than 25 nm, optionally no more than 15 nm, optionally no more than 10 nm, optionally about no more than 9 nm, optionally about no more than 8 nm, optionally about no more than 7 nm, optionally about no more than 6 nm, optionally about no more than 5 nm, optionally about no more than 4 nm, optionally about no more than 3 nm, optionally about no more than 2 nm, and optionally about no more than 1 nm. As a non-limiting example, FIG. 9B shows a copper core electrode material with an outer shell or coating (111) of about 3.2 angstroms.

According to some aspects, the shell may comprise a shell material that is compatible with a liquid type F-shuttle battery or fluoride ion battery. For example, the shell material may be selected such that dissolution of the cathode core material into the liquid electrolyte of the liquid type F-shuttle battery during charge and/or discharge may be reduced or eliminated. The thickness of the shell may be selected to provide a determined distance limit into an electrode material (electron conductivity, ion, or F— penetration). The shell material or thickness may be selected to further provide adequate charge time. As used herein, the term “charge time” refers to the length of time required for a discharged liquid type F-shuttle battery electrode to fully charge, that is, the length of time required for F⁻ in the fluoride conducting electrolyte to travel from the anode to the cathode during the charge of the battery. According to some aspects, the charge time may be between about 1 and 20 minutes, optionally been about 1 and 10 minutes, and optionally between about 3 and 5 minutes. However, the charge time is not limited and can, for example, depend upon temperature, battery size, and battery capacity.

According to some aspects, methods of making a cathode for a fluoride ion battery are disclosed herein, an example method comprising providing a solid transition metal and treating the solid transition metal with lanthanum and fluorine to form a LaF₃ shell at least partially surrounding the solid transition metal. As non-limiting examples, the solid transition metal can comprise bismuth, lead, copper, or combinations thereof. The treating can comprise dispersing the solid transition metal in an aqueous solution of hydrazine hydrate and contacting the solid transition metal with an aqueous solution of lanthanum ions and fluoride ions. An aqueous solution of lanthanum ions and fluoride ions can comprise lanthanum nitrate hexahydrate and sodium fluoride. Barium can be added to the solution, to form a barium containing shell in various embodiments. A LaF₃ cathode coating can be obtained from precipitation, by slowly adding NH₄F into La(NO₃)₃ aqueous solution with nanoparticles or structures having one or more dimensions at the distance limit of the core material suspended therein. The precipitation synthesis of the LaF₃ coating can be modified, by adding barium, to prepare a coating of La₁₋ₓBaₓF₃₋ₓ, wherein X=0-0.5. In some embodiments, the treating to form an electrode or cathode, can comprise radio frequency sputtering of LaF₃ or La₁₋ₓBaₓF₃₋ₓ onto a solid transition metal. In some embodiments, atomic layer deposition can be utilized to provide a coating or shell completely or partially covering an electrode core material. Anodes can be coated, using the various techniques disclosed herein, with fluorinated compounds or phenyl ring compounds comprising various functional groups. The electrodes disclosed herein can comprise various coatings to enable high energy fluoride ion batteries without, for example, dissolution of the electrodes. The coatings can be applied by any means known in the art. Atomic layer deposition offers a way to apply uniform coatings to electrodes for fluoride batteries.

According to some aspects, the shell material may comprise a “soft shell” material. As used herein, “soft” refers to a material that can include, but are not limited to, surfactants, certain polymers, a non-surfactant molecule having one or more specific functional groups, and combinations thereof. According to some aspects, the shell material may comprise an organic material, and in particular, an organic material that includes at least one material capable of forming a coating on an electrode under molecular layer deposition techniques. Examples of organic shell materials include, but are not limited to, organic soft-shell materials such as organic surfactants, organic or organic molecule-containing polymers, non-surfactant organic molecules, and combinations thereof.

In a non-limiting example, an electrode core material (FIG. 5A) can be coated by exposing the electrode core material to alternate gaseous species, one at a time, in atomic layer deposition. FIG. 5B illustrates a coating 12 formed on an electrode core material 11. For example, an electrode core material can be exposed to two gas phase precursors or reactants A and B in a sequential, non-overlapping way. In atomic layer deposition (ALD), a reactant reacts with the surface of an electrode core material in a self-limited way, and the reactant molecules can react only with a finite number of reactive sites on the surface of the electrode core material. Once all reactive sites have been consumed in atomic layer deposition, the growth or reaction stops. The remaining gas phase reactant molecules are flushed away and then gas phase reactant B is introduced into the reactor. By alternating exposures of A and B, one or more thin films can be deposited on an electrode material. Atomic layer deposition can be accomplished by thermal, plasma, catalytic, photo, chemical, vacuum, and vaporization techniques, for example.

Molecular layer deposition (MLD) is similar to ALD. MLD is a vapor phase thin film deposition technique based on self-limiting surface reactions carried out in a sequential manner. ALD is typically limited to inorganic coatings, the precursor chemistry in MLD can use small, bifunctional organic molecules. MLD enables, as well as the growth of organic layers in a process similar to polymerization, the linking of different layers together in a controlled way to build up organic-inorganic hybrid materials. ALD and MLD can be combined to form single or multi-layers.

Examples of shell layer materials that may be used according to the present disclosure include, but are not limited to, LaF₃, CeF₃, CaF₂, MgF₂, LaOF, CeOF, La₂O₃, CeO₂, CaO, MgO, La(OH)₃, Ca(OH)₂, Ce(OH)₃, Ce(OH)₃, Mg(OH)₂, La₁₋ₓBaₓF₃₋ₓ, organic molecules can be added, with barium added to any example, organic surfactants, and combinations thereof.

To form coated electrodes for fluoride batteries, an anode or cathode material (FIG. 1B, FIG. 5A) is placed into an ALD or MLD reactor or a reaction chamber of a reactor. The anode or cathode material can be hollow (FIG. 5C) and can take any shape. Gas-phase precursor 1 is pulsed in the reactor, where it reacts and chemisorbs to the exposed surface(s) of the electrode structure. Once all reactive, adsorption sites have been covered and saturation has been reached, no more precursor will attach to the electrode surface, and excess precursor molecules and generated byproducts are flushed from the vapor reactor, either by purging with inert gas, by pumping the reactor chamber down, or a combination of vacuum and inert gas. When the reactor has been purged with inert gas or pumped down to base pressure (e.g., ˜10⁻⁶ mbar range) and all molecules from the previous step have been removed, gas phase precursor 2 can be introduced. The described method is not a chemical vapor deposition (CVD-type) method, where the two precursors react or combine in the gaseous phase before attaching to the electrode surface, which would result in a coating with different characteristics. In some embodiments, a first gas phase precursor can form a first layer on the surface of an electrode material, and a second gas phase precursor can react or combine with the first layer, to form a single layer having a selected chemical composition.

After purging gas phase precursor 1 from the reactor, gas phase precursor 2 is pulsed into the reaction chamber. Precursor 2 can react with the previous precursor 1 molecules anchored to the electrode surface. This surface reaction is again self-limiting and, followed again by purging/pumping to base pressure the reactor, can leave behind a layer terminated with surface groups. Optionally, the surface groups can again react with precursor 1 in an optional next cycle. In some embodiments, the repetition of the ALD or MLD cycle can build up an organic/hybrid film one monoatomic layer at a time, enabling highly conformal coatings with precise thickness control and film purity. According to some aspects, a final precursor can be introduced to terminate surface groups with a desired outer coating. The ALD and MLD methods disclosed herein can provide a molecular thin uniform coating on a cathode or anode material, and the thin coating can allow for deeper F— penetration into an electrode material (increased distance limit). By applying additional cycles of ALD or MLD, a coating can be built up progressively into a thicker, single coating, or multi-layer coatings can be designed. The ALD and MLD methods can enable better coverage for smaller particles or for 2D electrode materials. A single ALD cycle can, in some embodiments, provide a uniform atomic coating of an electrode material.

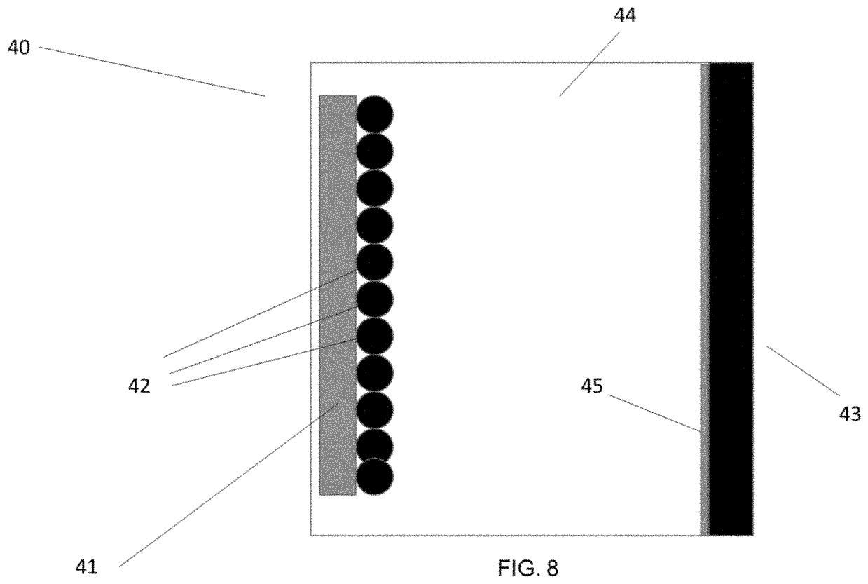

If ALD and MLD are combined, more precursors in a wider range can be used, both inorganic and organic. In addition, other reactions can be included in the ALD/MLD cycles as well, such as plasma or radical exposures. This way, a coating on an electrode can be customized, according to various embodiments of fluoride batteries, by tuning the number of ALD and MLD cycles and the steps and chemicals contained within the cycles. In some embodiments, as illustrated in FIG. 7A, an electrode material 31 can be coated with a first layer 32 and a second layer 33.

Precursor 1 or precursor 2 can be provided to the reaction chamber by radio frequency sputtering, plasma effects, thermal methods, high-vacuum vaporization, photo-induced methods, vaporization from solutions, or any technique that will provide a gas phase precursor to the exposed surface(s) of the electrode metal or material. Ozone can be introduced simultaneously, depending on the desired coating(s). The reaction chamber can be under vacuum and can comprise an inert gas. In some embodiments, a single gas phase precursor can be utilized to form an atomic or molecular coating. The atomic or molecular coating can be further coated using any variety of cycles or gas phase precursors to form one or more coatings on an electrode material.

The electrodes disclosed herein exhibit a higher stability than known electrodes, due to the outer shell(s). For example, the outer shell may protect the electrode core material from corrosion by an electrolyte solution and/or suppress hydrogen evolution reactions. The outer shell may protect an anode from dissolution while allowing passage of fluoride ion through the shell, but not passage of ions or electrons that degrade the anode. For example, the outer shell or one or more coatings can allow passage of fluoride ion while preventing corrosion of the electrode material. The outer shell may also reduce or inhibit carbon deposition and/or metal deposition from impurities in the electrolyte, which can reduce electrode performance over time. The electrodes of the present disclosure may also exhibit a higher activity and/or selectivity due, at least in part, to the desirable characteristics of the shell material, as described herein.

As shown in FIG. 5B, the solid electrode core material 11 may additionally comprise a second material 12 which coats the first material 11. For example, the coating may comprise a metal oxide, LaF₃, organic molecules, La₁₋ₓBaₓF₃₋ₓ, and combinations thereof. According to some aspects, a coating may be formed by repeated or varied cycles of ALD or MLD. The coating may provide complete coverage of the electrode material (i.e., cover 100% of the electrode material's surface area) or may provide partial coverage of the electrode material (i.e., cover less than 100% of the electrode material's surface area) as is shown in FIG. 7B.

A method for making an electrode for a fluoride ion battery, for example, can comprise providing an electrode core material comprising an electride, a metal, a lanthanide, an actinide, oxides thereof, or combinations thereof. The electrode core material can be placed into a reaction chamber for ALD or MLD reactions, and the reaction chamber can be under vacuum comprising an inert gas. A first gas phase precursor can be introduced into the reaction chamber, for example, La(2, 2, 6, 6-tetramethyl-3, 5-heptanedione)₃ in ozone. The gas phase precursor can be introduced by any means known in the art. The gas phase precursor contacts the exposed surface of the electrode material and react or combine with the exposed surface, to form a first coating or layer on the exposed surface of the electrode. Unreacted gas phase precursor remaining in the gas phase is flushed out of the reaction chamber by purging, by vacuum, or both. In contrast to chemical vapor deposition (CVD), the gas phase precursors are never present simultaneously in the reaction chamber, but they can be introduced into the reaction chamber as a series of sequential, non-overlapping pulses. In each of these pulses, the precursor molecules react with the electrode surface in a self-limiting way, so that the reaction terminates once all the reactive sites on the electrode surface are consumed. When initially preparing an electrode, the amount of time required to consume all the reactive sites on an exposed electrode surface can be measured by various means, for example, by measuring pressure or spectroscopy in the reaction chamber, or by spectroscopy or microscopy of an electrode surface, after a measured period of time.

After removing the first gas phase precursor from the reaction chamber, a second gas phase precursor can be introduced into the reaction chamber. The second gas phase precursor can react with the first coating or layer on the exposed surface of an electrode in a self-limiting way. The second gas phase precursor can react with the first coating or layer to form a single coating or layer having a desired chemical composition. In some embodiments, the second gas phase precursor can completely coat the first coating or layer. In some embodiments, the second gas phase precursor can form a second coating at least partially covering the first coating or layer. After the second gas phase precursor reacts with the exposed surface of an electrode, which comprises the first coating, the second gas phase precursor can be flushed or purged from the reaction chamber. Additional cycles of gas phase precursors can optionally be applied. Non-limiting examples of a second gas phase precursor include TiF₄ and/or 1, 1, 1, 5, 5, 5-hexafluoroacetylacetonate in ozone, which can be used to combine fluorine into a coating. A non-limiting example of a first gas phase precursor for a cathode is La₁₋ₓBaₓ(2, 2, 6, 6-tetramethyl-3, 5-heptanedione)₃, in ozone, wherein X=0 to 0.5.

The one or more coatings on an anode are referred to as an outer solid electrolyte interphase (SEI) layer. According to some aspects, an SEI layer can allow passage of fluoride ion while preventing passage of components corrosive to an anode core material. Anode coatings provided in ALD or MLD gas phase precursors can comprise fluorinated hydrocarbons, phenyl rings comprising one or more functional groups, or combinations thereof optionally in ozone.

According to some aspects, the ALD and MLD reactions described herein can be repeated or can comprise a third gas phase precursor, a fourth gas phase precursor, in as many different ALD or MLD steps as needed to form one or more desired coatings on an electrode material. Repeating the same ALD or MLD method steps can build up a thicker desired layer or coating on an electrode material. The present disclosure is not limited by the examples of gas phase precursors provided herein, as the ALD and MLD methods discussed herein enable coatings for fluoride battery electrodes with various chemical compositions and thicknesses.

In some embodiments, the first gas phase precursor can comprise multiple chemical compounds, or the first gas phase precursor can be a single compound. In some embodiments, the second and any optional additional gas phase precursors can comprise multiple chemical compounds or a single chemical compound. According to some aspects, ALD or MLD techniques or portions thereof known in the art may be utilized. Non-limiting examples include those described in U.S. Pat. Nos. 7,132,697; 9,284,643; and U.S. Patent Application Publication No. 20120009343.

The outer shell or coating(s) can be applied to cover areas of an electrode material with one or more dimensions at or near the distance limit. In some embodiments, one or more coatings can be applied to areas of the electrode that will be in contact with a liquid fluoride electrolyte. The outer shell may provide complete coverage of the electrode (i.e., cover 100% of the electrode core material surface area). For example, as shown in FIG. 1C and in FIG. 5B, the electrode 11 may comprise a solid core material having a first coating 12. FIG. 7A illustrates an electrode material 31 with a coating 32 and another coating 33. The outer shell may provide partial coverage of the electrode (i.e., cover less than 100% of the electrode surface area). For example, as shown in FIG. 7B, the electrode 31 may comprise a solid core having a first coating material 32 and a shell 34 covering a portion of the electrode, the portion covered referred to herein as percent shell coverage. The shell may cover at least 90% of the electrode surface area, at least 80% of the electrode surface area, at least 70% of the electrode surface area, at least 60% of the electrode surface area, at least 50% of the electrode surface area, at least 40% of the electrode surface area, at least 30% of the electrode surface area, at least 20% of the electrode surface area, or at least 10% of the electrode surface area.

According to some aspects, percent shell coverage may be selected to provide optimal performance. As used herein, the term “optimal performance” refers to performance at or near an electrode capacity for a selected performance parameter. For example, according to some aspects, percent shell coverage may be selected to provide optimal current density. Additionally, or alternatively, percent shell coverage may be selected to provide optimal electrode activity.

One or more of the percent shell coverages values described herein may correspond to an estimation. According to some aspects, the estimation may be obtaining using a model, wherein the model is based, at least in part, on the shape, size, and/or thickness of the electrode and/or components thereof. For example, percent shell coverage may be determined by estimating full shell coverage (i.e., 100% shell coverage) using a model and then comparing the estimated full shell coverage with the amount of shell material (or portions thereof) comprised by the electrode, wherein the amount of shell material (or portions thereof) is determined using one or more measuring devices and/or techniques known in the art, such as an Inductively Coupled Plasma (ICP) technique and/or an Energy-Dispersive X-ray Spectroscopy (EDS) technique. The shell coverages can be estimated by first determining the surface area of an electrode in contact with an electrolyte as 100% area. For example, if all surface area of an electrode in contact with an electrolyte has a coating or shell, the shell coverage of electrode material in contact with the electrolyte can be 100%.

The ALD and MLD techniques disclosed herein can be utilized to apply uniform coatings with thicknesses less than 1 angstrom (atomic level) for fluoride battery electrodes. According to some aspects, the uniform thin coatings can enable greater penetration of F— into an electrode core material, thereby increasing the distance limit of an electrode core material.

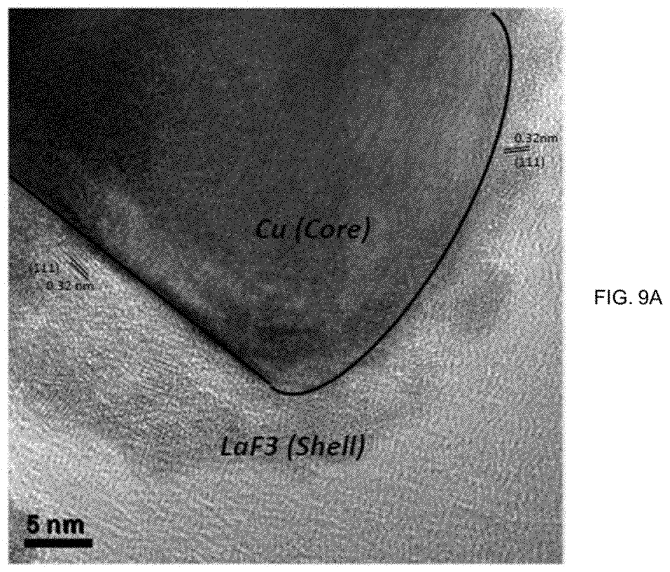

FIG. 8 is a non-limiting example of a fluoride ion battery utilizing coated electrodes as described herein. As shown in FIG. 8, a fluoride ion battery 40 of the present disclosure may comprise at least a cathode 41 comprising cathode materials with one or more coatings 42, an anode 43, comprising one or more solid electrolyte interphase layers 45 and a liquid fluoride electrolyte 44 between the anode and cathode. According to some aspects, the cathode core-shell particles 42 having a transition metal core and a shell at least partially surrounding the transition metal core can form a paste, can be combined with other compounds, can be dried, can be formed, can be agglomerated, or can be utilized by any means known in the art. In some embodiments, the core-shell particle having a transition metal core and a shell at least partially surrounding the transition metal core can be made into a paste with poly(vinylidene fluoride), PVDF and/or SP (Super P carbon black), pressed into stainless steel mesh, and dried under vacuum for an electrode assembly.

The electrodes of the present disclosure exhibit certain distinguishing properties over previously known electrodes. For example, electrodes according to the present disclosure may exhibit higher electrode activity, stability, faster recharge, durability in a fluoride liquid electrolyte, and selectivity compared with other electrodes known in the art. These distinguishing properties may, at least in part, result from the combination of the electrode core material and one or more outer shells, coatings, or layers. For example, the outer shell (or layers) may protect the electrode core material from corrosion by an electrolyte solution. The outer shell may also reduce or inhibit carbon deposition and/or metal deposition from impurities in the electrolyte, which can reduce electrode performance over time.

In some embodiments, the methods disclosed herein can be carried out, either partially or fully, under an inert atmosphere. An “inert atmosphere” refers to a gaseous mixture that contains little or no oxygen and comprises inert or non-reactive gases or gases that have a high threshold before they react. An inert atmosphere may be, but is not limited to, molecular nitrogen or an inert gas, such as argon, or mixtures thereof. Examples of inert gases useful according to the present disclosure include, but are not limited to, gases comprising helium (He), radon (Rd), neon (Ne), argon (Ar), xenon (Xe), nitrogen (N), and combinations thereof. An inert atmosphere can be under vacuum, such that a vacuum comprises an inert atmosphere.

The fluoride batteries disclosed herein are not limited by the examples provided. For example, an anode disclosed herein can be utilized without a cathode disclosed herein. Other liquid fluoride electrolytes can be utilized. A liquid electrolyte can comprise a non-aqueous solvent and a crown ether-metal halide complex including one or more halide ions selected from the group consisting of potassium, sodium, lithium, magnesium, and calcium ions wherein the crown ether-metal halide complex is at least partially dissolved, and the concentration of the halide ions dissolved in the electrolyte composition is, for example, 0.01 M to 1 M. The crown ether can comprise 18-crown-6, dibenzo-18-crown-6, 15-crown-5, and combinations thereof. The metal halide can comprise metal ions of potassium, sodium, lithium, magnesium, calcium ions, or combinations thereof. The metal halide can be a metal fluoride; a non-limiting example is potassium fluoride. Examples of suitable organic solvents are propanenitrile, 2,6-difluoropyridine, 2-fluorobenzonitrile, N-methyl-N-propylpiperidinium bis((trifluoromethyl)sulfonyl)amide, and bis(trifluoroethyl)ether. For example, the crown ether-metal halide complex can be present in a concentration of 0.08 M to 0.20 M. An electrolyte can be wherein the crown ether is 18-crown-6, the metal fluoride is potassium fluoride, and the crown ether-metal fluoride complex is 18-crown-6 potassium fluoride complex.

Liquid electrolyte salts suitable for a fluoride battery may contain complex cations in combination with a fluoride anion. The cation may feature organic groups, such as alkylammmonium, alkylphosphonium or alkylsulfonium species, or may consist of metal-organic or metal-coordination complex motifs, such as metallocenium species. Useful solvents for such liquid electrolyte salts may include non-aqueous solvents (denoted here as “organic”) that are capable of dissolving the aforementioned fluoride salts to molar concentrations of 0.01 M and above, preferred concentrations being between 0.1 and 3 M. Examples of such solvents include acetone, acetonitrile, benzonitrile, 4-fluorobenzonitrile, pentafluorobenzonitrile, triethylamine (TEA), diisopropylethylamine, 1,2-dimethoxyethane, ethylene carbonate, propylene carbonate (PC), γ-butyrolactone, dimethyl carbonate, diethyl carbonate (DEC), methyl ethyl carbonate, propyl methyl carbonate, tetrahydrofuran, 2-methyltetrahydrofuran, nitromethane, benzene, toluene, chloroform, dichloromethane, 1,2-dichloroethane, dimethylsulfoxide, sulfolane, N,N-dimethylformamide (DMF), N,N-dimethylacetamide (DMA), carbon disulfide, ethyl acetate, methyl butyrate, n-propyl acetate, methyl propionate, methyl formate, 4-methyl-1,3,-dioxolane, pyridine, methyl isobutyl ketone, methyl ethyl ketone, hexamethylphosphoramide, hexamethylphosphorus triamide, 1 methyl-2-pyrrolidinone, 2-methoxyethyl acetate, trimethyl borate, triethylborate and substituted derivatives thereof, as well as sulfones such as ethylmethylsulfone, trimethylene sulfone, 1-methyltrimethylene sulfone, ethyl-sec-butyl sulfone, ethyl isopropyl sulfone (EIPS), 3,3,3-trifluoropropylmethyl sulfone, 2,2,2-trifluoroethyl sulfone, bis(2,2,2-trifluoroethyl)ether (BTFE), glymes (e.g., diglyme, triglyme, tetraglyme), 1,2-dimethoxyethane (DME) and mixtures thereof. In certain embodiments, room temperature ionic liquid materials, or ionic liquids that remain liquid at temperatures below 200 degrees Celsius can be utilized. These can include ionic liquids that remain liquid at temperatures below 100 degrees Celsius such as 1-methyl,1-propylpiperidinium bis (trifluoromethanesulfonyl)imide (MPPTFSI), butyltrimethylammonium bis (trifluoromethanesulfonyl)imide (BTMATFSI) and 1-butyl,1-methyl pyrrolidinium bis (trifluoromethanesulfonyl) imide (BMPTFSI) and their fluoroalkylphosphate (FAP) anion derivatives (e.g. MPPFAP) where FAP is a hydrophobic anion such as tris (pentafluroethyl) trifluorophosphate, all of which alone or in combination can be useful solvents.

In some embodiments, the electrolytes suitable for a FIB can include the compositions disclosed above with the addition of a fluoride-ion complexing species such as an anion receptor, a cation complexing species such as a crown ether, or a combination of both. Suitable anion receptors include species capable of binding fluoride anion such as boron, aluminum, ammonium, H-bond donor or similar groups, including aza ethers, alkyl and aryl boron and boronate complexes, and boroxin species. Tris(hexafluoroisopropyl)borate, tris(pentafluorophenyl)borane and all possible regioisomers of difluorophenyl boroxin (DFB), trifluorophenyl boroxin, bis(trifluoromethyl)phenyl boroxin, trifluoromethyl)phenyl boroxin and fluoro (trifluoromethyl) phenyl boroxin can be used.

Dry N, N, N-trimethyl-N-neopentylammonium fluoride (Np₁F) and N, N, N-dimethyl-N, N-dineopentylammonium fluoride (Np₂F) provide ionic conductivity with electrolyte longevity in organic solvents. In one embodiment, ionic conductivity measurements for NpMe₃NF (0.07 M) in PN, NpMe₃NF (0.22 M) in 2,6-F2Py, NpMe3NF (0.35 M) in 2,6-F2Py, NpMe₃NF (1.0 M) in BTFE, and NpMe3NF (0.38 M) in PhTFA were performed. These measurements indicate that all solutions exhibit appreciable ionic conductivity (>0.1 mS/cm) at room temperature (25° C.). In particular, about 1 M NpMe₃NF in BTFE displays a conductivity of 2.7 mS/cm at 25° C., a value being high enough for fluoride ion battery (FIB) applications.

Ionic conductivity of NpMe₃NF and Np₂Me₂NF was measured in BTFE and mixtures of BTFE and PN at different temperatures. Test results indicate that addition of increasing amounts of PN is observed to increase the conductivity significantly at nearly all temperatures. Notably, Np₂Me₂NF is observed to be more soluble in PN than NpMe₃NF, in contrast to BTFE.

Further characterization of solvent mixtures was performed using NpMe₃NF and Np₂Me₂NF salts in the solvents or solvent mixtures disclosed above. Using the NpMe₃NF solutions, in certain cases, the conductivity may be increased from that observed for a BTFE mixture of salt at a given concentration through use of a solvent mixture. Glymes (e.g., dimethoxyethane) and amides may be useful co-solvents to achieve such an effect. Using the Np₂Me₂NF solutions, in certain cases, higher conductivity values can be observed compared to that for NpMe₃NF mixtures due to the higher solubility of the Np₂Me₂NF salt in certain solvents and mixtures.

Voltage windows of NpMe₃NF solutions were investigated using linear sweep voltammetry. A Pt working electrode, Pt auxiliary and non-aqueous Ag⁺/Ag (MeCN) reference electrode, with Ar purge were employed in the experiments. The voltage windows for a limiting current of 100 μA/cm² were measured at 1 mV/s for electrolyte solutions of 0.75M NpMe₃NF/BTFE:DMA (3:2), 0.75M NpMe₃NF/BTFE:G4 (3:2), 1M NpMe₃NF/BTFE, 0.75M NpMe₃NF/BTFE:DME (3:2), and 0.1M NpMe₃NF/PN (triglyme=G3, tetraglyme=G4).

The voltage window data, as depicted in FIG. 4, suggest that these non-aqueous electrolyte solutions may possess a useful electrochemical window of at least 3V. Combined with their high conductivity, these non-aqueous solutions of fluoride salts may be employed as electrolytes for electrochemical applications such as fluoride-ion batteries, electrochemical double-layer capacitors and in electrochemical fluorination reactions.

In some embodiments, the shells or layers disclosed herein can comprise surfactants. According to some aspects, a surfactant may comprise a surfactant useful for preparing the electrode material (core), such as a surfactant having one or more functional groups selected from the group consisting of a polar head (e.g., a polar head comprising one or more of the specific functional groups as described herein), a carbon-containing tail (e.g., alkanes, alkynes, alkenes, and aromatic rings), a fluorocarbon-containing tail (e.g., aliphatic chains such as (CF₂)ₙ, (CHF)ₙ, (CH₂CF₂)ₙ, and (CH₂OCH₂CF₂)ₙ, and/or aromatic groups such as (C₆₋ₓFₓ—)ₙ), and combinations thereof. Examples of surfactants useful according to the present disclosure may include, but are not limited to, oleylamine, oleic acid, tris(trimethylsilyl)silane, 3, 3, 4, 4, 5, 5, 6, 6, 7, 7, 8, 8, 9, 9, 10, 10, 10-heptadecafluorodecanethiol, 2-(trifluoromethoxy)-benzenethiol, P-[12-(2, 3, 4, 5, 6-pentafluorophenoxy)dodecyl]-Phosphonic acid, P-(3, 3, 4, 4, 5, 5, 6, 6, 7, 7, 8, 8, 9, 9, 10, 10, 10-heptadecafluorodecyl)-Phosphonic acid, pentafluoro benzylphosphonic acid, perfluoro dodecanoic acid and combinations thereof.

According to some aspects, the shells or layers disclosed herein can comprise polymers. According to some aspects, the certain polymers may comprise polymers capable of being formed via in-situ polymerization, particularly polymers capable of being formed via in-situ polymerization from their monomers or from shorter oligomeric species. Additionally, or alternatively, the certain polymers may be capable of self-healing through hydrogen bonding. For example, the certain polymers may be capable of hydrogen bonding such as to autonomously and repeatedly “self-heal” imperfections in the shell or coating, such as cracks and/or gaps that may result at least in part from volume expansion and/or contraction of an electrode during charge and discharge. Examples of such polymers include, but are not limited to, polyvinylpyrrolidone (PVP), poly(methyl methacrylate) (PMMA), amino-terminated, and C═O bond included cross linked polymers.

According to some aspects, the shell or coating may comprise one or more monolayers. In some embodiments, the shell or coating can comprise one, two, three, or more monolayers. According to some aspects, each of the monolayers may be the same or different.

A “reducing agent” is a substance that causes the reduction of another substance, while it itself is oxidized. Reduction refers to a gain of electron(s) by a chemical species, and oxidation refers to a loss of electron(s) by a chemical species. The shells or coatings disclosed herein can comprise organic molecules. Any of the surfactants, polymers, and organic molecules can be, in various embodiments, combined, added, or solely utilized in ALD or MLD methods to provide a shell or coating on an electrode material.

As used herein, a “metal salt” is an ionic complex wherein the cation(s) is(are) a positively charged metal ion(s) and the anion(s) is(are) a negatively charged ion(s). “Cation” refers to a positively charged ion, and “anion” refers to a negatively charged ion. In a “metal salt” according to the present disclosure, the anion may be any negatively charged chemical species. Metals in metal salts according to the present disclosure may include but are not limited to alkali metal salts, alkaline earth metal salts, transition metal salts, aluminum salts, or post-transition metal salts, and hydrates thereof.

“Alkali metal salts” are metal salts in which the metal ions are alkali metal ions, or metals in Group I of the periodic table of the elements, such as lithium, sodium, potassium, rubidium, cesium, or francium.

“Alkaline earth metal salts” are metal salts in which the metal ions are alkaline earth metal ions, or metals in Group II of the periodic table of the elements, such as beryllium, magnesium, calcium, strontium, barium, or radium.

“Transition metal salts” are metal salts in which the metal ions are transition metal ions, or metals in the d-block of the periodic table of the elements, including the lanthanide and actinide series. Transition metal salts include, but are not limited to, salts of scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, actinium, thorium, protactinium, uranium, neptunium, plutonium, americium, curium, berkelium, californium, einsteinium, fermium, mendelevium, nobelium, and lawrencium.

“Post-transition metal salts” are metal salts in which the metal ions are post-transition metal ions, such as gallium, indium, tin, thallium, lead, bismuth, or polonium.

A “fluoride salt” is an ionic complex in which the anion(s) is(are) fluoride ion(s). According to the present disclosure, the cation of the fluoride salt may be any positively charged chemical species.

A “metal fluoride” is an ionic complex in which the cation is a metal ion and the anion(s) is(are) fluoride ion(s). According to the present disclosure, the metal salt and the fluoride salt react to create a metal fluoride shell around the metal nanoparticle core.

The term “electrochemical cell” refers to devices and/or device components that facilitate chemical reactions through the introduction of electrical energy. Electrochemical cells have two or more electrodes (e.g., positive and negative electrodes) and an electrolyte. Fluoride battery, as used herein, can be a fluoride ion battery or a fluoride shuttle battery.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

As used herein, the term “about” is defined to being close to as understood by one of ordinary skill in the art. In one non-limiting embodiment, the term “about” is defined to be within 10%, preferably within 5%, more preferably within 1%, and most preferably within 0.5%.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

What is claimed is:

1. A fluoride ion battery comprising:
an anode;
a cathode containing a core and a shell at least partially surrounding the core, wherein the shell has a thickness of no more than 25 nm; and
a liquid electrolyte containing fluoride ions between the anode and the cathode.

2. The fluoride ion battery of claim 1, wherein the core comprises copper and the shell comprises LaF₃.

3. The fluoride ion battery of claim 1, wherein the shell comprises La₁₋ₓBaₓF₃₋ₓ, wherein X=0-0.5.

4. The fluoride ion battery of claim 1, wherein the shell comprises La₁₋ₓBaₓF₃₋ₓ, wherein X=0.03.

5. The fluoride ion battery of claim 1, wherein the liquid electrolyte comprises bis(2-methoxyethyl) ether, bis(2,2,2-trifluoroethyl) ether, N,N,N-trimethyl-N-neopentylammonium fluoride, N,N,N-dimethyl-N,N-dineopentylammonium fluoride, propionitrile, or a combination thereof.

6. The fluoride ion battery of claim 1,
wherein the liquid electrolyte comprises a non-aqueous solvent and a crown ether-metal halide complex comprising one or more halide ions selected from the group consisting of potassium, sodium, lithium, magnesium, and calcium ions, and
wherein the crown ether-metal halide complex is at least partially dissolved and the concentration of the halide ions dissolved in the electrolyte composition is 0.01 M to 1 M.

7. The fluoride ion battery of claim 6, wherein the crown ether is selected from the group consisting of 18-crown-6, dibenzo-18-crown-6, and 15-crown-5.

8. The fluoride ion battery of claim 1, wherein the core has at least one dimension less than or equal to about 20 nm.

9. The fluoride ion battery of claim 1, wherein the thickness of the shell is no more than 15 nm.

10. The fluoride ion battery of claim 1, wherein the thickness of the shell is no more than 1 nm.

11. The fluoride ion battery of claim 1, wherein the anode comprises an alkali earth metal, a rare earth metal, or a combination thereof.

12. The fluoride ion battery of claim 1, wherein the anode comprises an outer solid electrolyte interphase layer comprising a fluorinated hydrocarbon, a phenyl ring comprising a functional group, or a combination thereof.

13. The fluoride ion battery of claim 1, wherein the core comprises a transition metal, a lanthanide, an actinide, an electride, or a combination thereof.

14. A method of making a cathode for a fluoride ion battery, the method comprising:
a) providing a core;
b) treating the core with a first gas phase precursor such that the first gas phase precursor reacts with a surface of the core to form a first coating on the core; and
c) treating the core with a second gas phase precursor such that the second gas phase precursor reacts with the first coating to form a second coating on the first coating.

15. The method of claim 14, wherein the first gas phase precursor is La(2, 2, 6, 6-tetramethyl-3, 5-heptanedione)₃ in ozone.

16. The method of claim 14, wherein the first gas phase precursor is La₁₋ₓBaₓ(2, 2, 6, 6-tetramethyl-3, 5-heptanedione)₃, in ozone, wherein X=0 to 0.5.

17. The method of claim 14, wherein the first gas phase precursor comprises a fluorinated hydrocarbon, a phenyl ring comprising a functional group, or combinations thereof in ozone.

18. The method of claim 14, wherein the second gas phase precursor is TiF₄ or 1, 1, 1, 5, 5, 5-hexafluoroacetylacetonate in ozone.

19. The method of claim 14, wherein a combined thickness of the first coating and the second coating is from 0.3 to 1 angstrom.

20. The method of claim 14, further comprising heating the core to a temperature of from 50° C. to 300° C.

21. The method of claim 14, wherein the core comprises copper.

22. The method of claim 14, wherein the treating of the core with the first gas phase precursor and/or the second gas phase precursor is conducted in a vacuum atmosphere.

23. The method of claim 22, wherein the vacuum atmosphere comprises one or more inert gases.

24. The method of claim 14, wherein the first gas phase precursor is provided by radio frequency sputtering.

25. The method of claim 14, wherein the core comprises a metal, a lanthanide, an actinide, or a combination thereof.

26. The method of claim 14, further comprising a step of removing the first gas phase precursor prior to c).
